(19) United States
(12) Patent Application Publication
(10) Pub. No.: US 2025/0068504 A1
(43) Pub. Date: Feb. 27, 2025

(54) ZERO TOUCH OPERATIONS AND SELF-HEALING DATA PLATFORM

(71) Applicant: T-MOBILE INNOVATIONS LLC, Overland Park, KS (US)

(72) Inventors: Vikas RANJAN, Bellevue, WA (US); Jai Devinder Singh MATHAROO, Aldie, VA (US); Arunkumar SINGARAVELU, Bellevue, WA (US); Kamalakar Reddy VATHYARAM, Bellevue, WA (US); Armanullah SIDDIQUI, Beaverton, OR (US); Senthil Kumar PUGAZHENDHI, Bellevue, WA (US)

(21) Appl. No.: 18/236,818

(22) Filed: Aug. 22, 2023

(51) Int. Cl. G06F 11/07

(52) U.S. Cl. CPC G06F 11/0793; G06F 11/079

(57) ABSTRACT

Systems and methods are provided for providing a zero touch operations and self-healing data platform. Initially, data corresponding to a mobile communications network is received from a plurality of sources. A machine learning model is trained to detect anomalies corresponding to the data. Upon detecting an anomaly, self-remediation is initiated. Upon determining the self-remediation exceeds a configurable number of attempts or duration, an action is automatically performed. In various aspects, the action includes automatically initiating an alert corresponding to the anomaly or automatically creating a ticket corresponding to the anomaly.

### SUMMARY

A high-level overview of various aspects of the present technology is provided in this section to introduce a selection of concepts that are further described below in the detailed description section of this disclosure. This summary is not intended to identify key or essential features of the claimed subject matter, nor is it intended to be used as an aid in isolation to determine the scope of the claimed subject matter.

In aspects set forth herein, systems and methods are provided for providing a zero touch operations and self-healing data platform. More particularly, in aspects set forth herein, systems and methods enable multiple petabytes of complex network logs to be processed without requiring manual inspection, troubleshooting, and resolution of system and application issues. To do so, data corresponding to a mobile communications network is initially received from a plurality of sources. A machine learning model is trained to detect anomalies corresponding to the data. Upon detecting an anomaly, self-remediation is initiated. Upon determining the self-remediation exceeds a configurable number of attempts or duration, an action is automatically performed. In various aspects, the action includes automatically initiating an alert corresponding to the anomaly or automatically creating a ticket corresponding to the anomaly.

### BRIEF DESCRIPTION OF THE SEVERAL VIEWS OF THE DRAWINGS

Implementations of the present disclosure are described in detail below with reference to the attached drawing figures, wherein:

FIG. 1 depicts a diagram of an exemplary network environment in which implementations of the present disclosure may be employed:

FIG. 2 illustrates an example self-healing engine, in accordance with aspects herein:

FIG. 3 depicts a flow diagram of a method for providing a zero touch operations and self-healing data platform, in accordance with aspects herein:

FIG. 4 depicts a diagram of an exemplary computing environment suitable for use in implementations of the present disclosure.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Throughout this disclosure, several acronyms and shorthand notations are employed to aid the understanding of certain concepts pertaining to the associated system and services. These acronyms and shorthand notations are intended to help provide an easy methodology of communicating the ideas expressed herein and are not meant to limit the scope of embodiments described in the present disclosure. The following is a list of these acronyms:
3G Third-Generation Wireless Technology
4G Fourth-Generation Cellular Communication System
5G Fifth-Generation Cellular Communication System
6G Sixth-Generation Cellular Communication System
AI Artificial Intelligence
CD-ROM Compact Disk Read Only Memory
CDMA Code Division Multiple Access
eNodeB Evolved Node B
GIS Geographic/Geographical/Geospatial Information System
gNodeB Next Generation Node B
GPRS General Packet Radio Service
GSM Global System for Mobile communications
iDEN Integrated Digital Enhanced Network
DVD Digital Versatile Discs
EEPROM Electrically Erasable Programmable Read Only Memory
LED Light Emitting Diode
LTE Long Term Evolution
MIMO Multiple Input Multiple Output
MD Mobile Device
ML Machine Learning
PC Personal Computer
PCS Personal Communications Service
PDA Personal Digital Assistant
PDSCH Physical Downlink Shared Channel
PHICH Physical Hybrid ARQ Indicator Channel
PUCCH Physical Uplink Control Channel
PUSCH Physical Uplink Shared Channel
RAM Random Access Memory
RET Remote Electrical Tilt
RF Radio-Frequency
RFI Radio-Frequency Interference
R/N Relay Node
RNR Reverse Noise Rise
ROM Read Only Memory
RSRP Reference Signal Receive Power
RSRQ Reference Signal Receive Quality
RSSI Received Signal Strength Indicator
SINR Transmission-to-Interference-Plus-Noise Ratio
SNR Transmission-to-noise ratio
SON Self-Organizing Networks
TDMA Time Division Multiple Access
TXRU Transceiver (or Transceiver Unit)
UE User Equipment
UMTS Universal Mobile Telecommunications Systems
WCD Wireless Communication Device (interchangeable with UE)

Further, various technical terms are used throughout this description. An illustrative resource that fleshes out various aspects of these terms can be found in Newton's Telecom Dictionary, 32^{nd} Edition (2022).

Embodiments of the present technology may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions—including data structures and program modules—in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

By way of background, a traditional telecommunications network employs a plurality of base stations (i.e., access point, node, cell sites, cell towers) to provide network coverage. The base stations are employed to broadcast and transmit transmissions to user devices of the telecommunications network. An access point may be considered to be a portion of a base station that may comprise an antenna, a radio, and/or a controller. In aspects, an access point is defined by its ability to communicate with a user equipment (UE), such as a wireless communication device (WCD), according to a single protocol (e.g., 3G, 4G, LTE, 5G, and the like); however, in other aspects, a single access point may communicate with a UE according to multiple protocols. As used herein, a base station may comprise one access point or more than one access point. Factors that can affect the telecommunications transmission include, e.g., location and size of the base stations, and frequency of the transmission, among other factors. The base stations are employed to broadcast and transmit transmissions to user devices of the telecommunications network. Traditionally, the base station establishes uplink (or downlink) transmission with a mobile handset over a single frequency that is exclusive to that particular uplink connection (e.g., an LTE connection with an eNodeB). In this regard, typically only one active uplink connection can occur per frequency. The base station may include one or more sectors served by individual transmitting/receiving components associated with the base station (e.g., antenna arrays controlled by an eNodeB). These transmitting/receiving components together form a multi-sector broadcast arc for communication with mobile handsets linked to the base station.

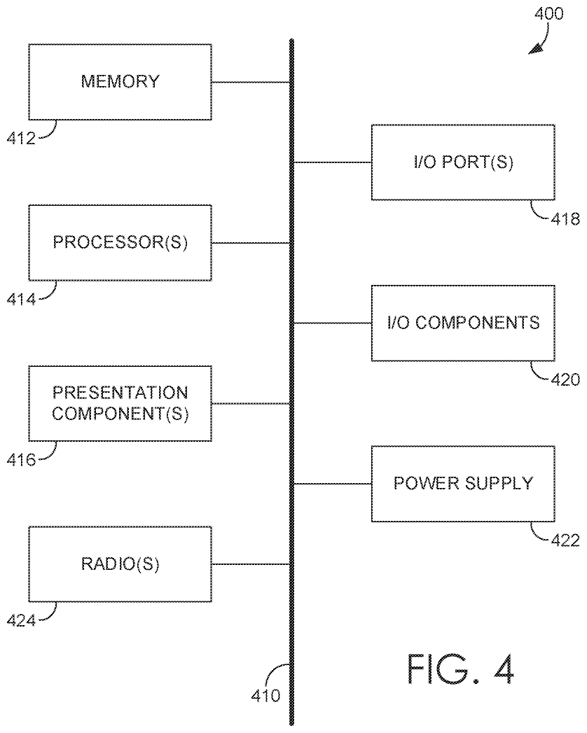

As used herein, “base station” is one or more transmitters or receivers or a combination of transmitters and receivers, including the accessory equipment, necessary at one location for providing a service involving the transmission, emission, and/or reception of radio waves for one or more specific telecommunication purposes to a mobile station (e.g., a UE), wherein the base station is not intended to be used while in motion in the provision of the service. The term/abbreviation UE (also referenced herein as a user device or wireless communications device (WCD)) can include any device employed by an end-user to communicate with a telecommunications network, such as a wireless telecommunications network. A UE can include a mobile device, a mobile broadband adapter, or any other communications device employed to communicate with the wireless telecommunications network. A UE, as one of ordinary skill in the art may appreciate, generally includes one or more antennas coupled to a radio for exchanging (e.g., transmitting and receiving) transmissions with a nearby base station. A UE may be, in an embodiment, similar to device 400 described herein with respect to FIG. 4.

As used herein, UE (also referenced herein as a user device or a wireless communication device) can include any device employed by an end-user to communicate with a wireless telecommunications network. A UE can include a mobile device, a mobile broadband adapter, a fixed location or temporarily fixed location device, or any other communications device employed to communicate with the wireless telecommunications network. For an illustrative example, a UE can include cell phones, smartphones, tablets, laptops, small cell network devices (such as micro cell, pico cell, femto cell, or similar devices), and so forth. Further, a UE can include a sensor or set of sensors coupled with any other communications device employed to communicate with the wireless telecommunications network: such as, but not limited to, a camera, a weather sensor (such as a rain gage, pressure sensor, thermometer, hygrometer, and so on), a motion detector, or any other sensor or combination of sensors. A UE, as one of ordinary skill in the art may appreciate, generally includes one or more antennas coupled to a radio for exchanging (e.g., transmitting and receiving) transmissions with a nearby base station or access point.

Conventional mobile communications network systems receive multiple petabytes of complex network logs to support various business initiatives internally for thousands of users. These systems typically run 24×7×365 processing hundreds of terabytes of data each day. Monitoring, troubleshooting, and resolving issues corresponding to the network logs and various jobs corresponding to the underlying data in conventional systems requires manual inspection. Moreover, the data is spread across numerous dashboards, thousands of daily jobs, and tens of thousands of alerts. As a result, the mean time to repair (MTTR) system issues is anywhere from eight to thirty-six hours while MTTR for job execution issues is over eight hours. Moreover, not all issues are detected and trouble tickets to address the issues are not created as the manual inspection is prone to human error.

The present disclosure is directed to systems, methods, and computer readable media for providing a zero touch operations and self-healing data platform. Multiple petabytes of complex network logs can be processed without requiring manual inspection, troubleshooting, and resolution of system and application issues. To do so, data corresponding to a mobile communications network is initially received from a plurality of sources. A machine learning model is trained to detect anomalies corresponding to the data. Upon detecting an anomaly, self-remediation is initiated. Upon determining the self-remediation exceeds a configurable number of attempts or duration, an action is automatically performed. In various aspects, the action includes automatically initiating an alert corresponding to the anomaly or automatically creating a ticket corresponding to the anomaly.

In this way a single pane of glass provides automation, in near-real time, inspection of the data and job execution. Moreover, early detection of system and application issues, smart alerting, self-healing (e.g., automated restart of faulty platform services, automatic load balancing of over-utilized system resources, and the like), and auto-ticketing are all enabled and nearly eliminate the need for human intervention. As a result, human resources can be reduced and/or reallocated, MTTR for system issues is reduced from eight to thirty-six hours to approximately seven minutes and MTTR for job execution issues is reduced from over eight hours to ten minutes, nearly fifty percent of all issues can be self-healed, and tickets for unresolved issues can be automatically created.

A first aspect of the present disclosure is directed to a method for providing a zero touch operations and self-healing data platform. Data corresponding to a mobile communications network is received from a plurality of sources. A machine learning model is trained to detect anomalies corresponding to the data. Self-remediation is initiated for an anomaly of the anomalies. Upon determining the self-remediation exceeds a configurable number of attempts or duration of time, an action is automatically performed.

A second aspect of the present disclosure is directed to a non-transitory computer storage media storing computer-usable instructions that when used by one or more processors, cause the one or more processors to perform operations. The operations comprise receiving data corresponding to a communications network. The data is received from a plurality of sources. The operations also comprise training a machine learning model to detect anomalies corresponding to the data. The operations further comprise initiating self-remediation for an anomaly of the anomalies. The operations also comprise, upon determining the self-remediation exceeds a configurable number of attempts or duration of time, automatically performing an action.

Another aspect of the present disclosure is directed to a system for communicating service type in a paging message for 4G/5G cellular communications. The system comprises one or more UEs and a node configured to wirelessly communicate with the one or more UEs. Then node is configured to: 1) receive data corresponding to a mobile communications network, the data received from a plurality of sources: 2) train a machine learning model to detect anomalies corresponding to the data: 3) initiate self-remediation for an anomaly of the anomalies; and 4) upon determining the self-remediation exceeds a configurable number of attempts or duration of time, automatically perform an action.

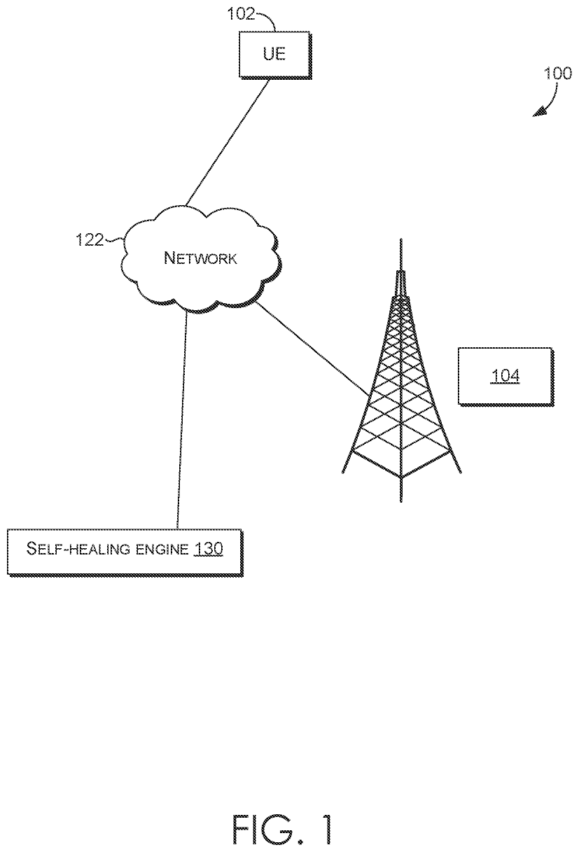

Turning to FIG. 1, a network environment suitable for use in implementing embodiments of the present disclosure is provided. Such a network environment is illustrated and designated generally as network environment 100. Network environment 100 is but one example of a suitable network environment and is not intended to suggest any limitation as to the scope of use or functionality of the disclosure. Neither should the network environment 100 be interpreted as having any dependency or requirement relating to any one or combination of components illustrated.

A network cell may comprise a base station to facilitate wireless communication between a communications device within the network cell, such as communications device 400 described with respect to FIG. 4, and a network. As shown in FIG. 1, a communications device may be a UE 102. In the network environment 100, UE 102 may communicate with other devices, such as mobile devices, servers, etc. The UE 102 may take on a variety of forms, such as a personal computer, a laptop computer, a tablet, a netbook, a mobile phone, a Smart phone, a personal digital assistant, or any other device capable of communicating with other devices. For example, the UE 102 may take on any form such as, for example, a mobile device or any other computing device capable of wirelessly communication with the other devices using a network. Makers of illustrative devices include, for example, Research in Motion, Creative Technologies Corp., Samsung, Apple Computer, and the like. A device can include, for example, a display(s), a power source(s) (e.g., a battery), a data store(s), a speaker(s), memory, a buffer(s), and the like. In embodiments, UE 102 comprises a wireless or mobile device with which a wireless telecommunication network(s) can be utilized for communication (e.g., voice and/or data communication). In this regard, the UE 102 can be any mobile computing device that communicates by way of, for example, a 5G network.

The UE 102 may utilize network 122 to communicate with other computing devices (e.g., mobile device(s), a server(s), a personal computer(s), etc.). In embodiments, network 122 is a telecommunications network, or a portion thereof. A telecommunications network might include an array of devices or components, some of which are not shown so as to not obscure more relevant aspects of the invention. Components such as terminals, links, and nodes (as well as other components) may provide connectivity in some embodiments. Network 122 may include multiple networks, as well as being a network of networks, but is shown in more simple form so as to not obscure other aspects of the present disclosure. Network 122 may be part of a telecommunications network that connects subscribers to their immediate service provider. In embodiments, network 122 is associated with a telecommunications provider that provides services to user devices, such as UE 102. For example, network 122 may provide voice services to user devices or corresponding users that are registered or subscribed to utilize the services provided by a telecommunications provider. Although it is contemplated network 122 can be any communication network providing voice and/or data service(s), such as, for example, a 1× circuit voice, a 3G network (e.g., CDMA, CDMA1000, WCDMA, GSM, UMTS), a 4G network (WiMAX, LTE, HSDPA), or the like, network 122 is depicted in FIG. 1 as a 5G network.

As previously mentioned, the UE 102 may communicate with other devices by using a base station, such as base station 104. In embodiments, base station 104 is a wireless communications station that is installed at a fixed location, such as at a radio tower, as illustrated in FIG. 1. The radio tower may be a tall structure designed to support one or more antennas for telecommunications and/or broadcasting. In other embodiments, base station 104 is a mobile base station. The base station 104 may be an MMU and include gNodeB for mMIMO/5G communications via network 122. In this way, the base station 104 can facilitate wireless communication between UE 102 and network 122.

Although shown with a single UE 102 and a single base station 104 for simplicity, the network 122 comprises a plurality of base stations each supporting and providing services to a plurality of UEs. As such, the network 122 is continuously generating large amounts of data corresponding to various aspects of the network 122, each UE, and each base station. This data may be received by a self-healing engine 130.

The self-healing engine 130 may be configured to, among other things, provide a zero touch operations and self-healing data platform, in accordance with the present disclosure. Though self-healing engine 130 is illustrated as a standalone device (e.g., a server having one or more processors), it may be a plurality of devices providing the functionality described herein and may be remotely located. The self-healing engine 130 may receive, among other things, data from a plurality of sources, such as UE 102, within a network cell associated with a particular base station 104, or infrastructure supporting the network itself. For example, the data may include event data records, call data records, and/or location session records. A server-based agent (e.g., TELEGRAF) may collect and send metrics and events from various databases, systems, and IoT sensors within the network to the self-healing engine 130. The incoming data may be load balanced across a number of secure file transfer protocol (SFTP) servers of the self-healing engine 130.

In some aspects, the data is processed by the self-healing engine 130. First, one or more files corresponding to the data is read. Next, the one or more files are queued for job scheduling. For example, the one or more files may be queued by the self-healing engine 130 using a message-broker software application (e.g., RABBITMQ) that supports message queuing protocols (e.g., Advanced Message Queuing Protocol, Streaming Text Oriented Messaging Protocol, MQ Telemetry Transport, and the like). In some aspects, the data is monitored in near real-time. In some aspects, a software application (e.g., NAGIOS CORE) may be utilized by the self-healing engine 130 to monitor the data.

In some aspects, a software application (e.g., GRAFANA) may be utilized by the self-healing engine 130 to monitor the health of the zero touch operations and self-healing data platform and provide a user interface to manage the resources of the platform. Additionally or alternatively, a dashboard application (e.g., AMBARI) may be utilized by the self-healing engine 130 to monitor the health and status of the zero touch operations and self-healing data platform itself.

The self-healing engine 130 may be part of a cluster (e.g. an APACHE HADOOP cluster). The cluster may leverage a real-time computation system (e.g., APACHE STORM) to process unbounded streams of data, in real-time. To provide real-time read/write access to the data, the self-healing engine 130 may utilize a distributed, scalable, big data store (e.g., APACHE HBASE). System resources to various applications running on the platform may be allocated by an allocation application (e.g., YARN). The allocation application may additionally enable tasks to be scheduled on different nodes. A data warehouse application (e.g., APACHE HIVE) may provide data query and analysis capabilities for the data. A gateway (e.g., APACHE KNOX) may be utilized by the self-healing engine 130 to provide security to extend access to the platform to various users that may need to access the data and execute jobs. In some aspects, job execution for the cluster originating from different application groups across multiple servers may be monitored by the self-healing engine 130 using a monitoring application (e.g., CONTROL-M).

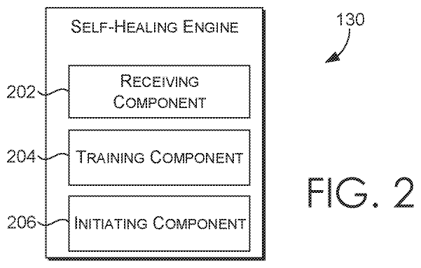

Referring now to FIG. 2, the self-healing engine 130 may include, among other things, receiving component 202, training component 204, and initiation component 206. Receiving component 202 generally receives data corresponding to a mobile communications network from a plurality of sources. In some aspects, the data comprises event data records, call data records, and/or location session records. Training component 204 generally detects anomalies corresponding to the data. Training component 204 may be trained to detect patterns among various elements of the data. For example, a single data point may not, in and of itself, indicate an anomaly. However, if the single data point is detected along with other data points that form a pattern the training component 204 has been trained to detect, an anomaly may be present and detected.

Initiating component 206 generally initiates self-remediation for an anomaly of the anomalies. In some aspects, self-remediation comprises automated restarting of faulty platform services. In some aspects, self-remediation comprises automated load balancing of over-utilized system resources. For example, for anomalies corresponding to VASD, I/O error, RAID, BBU, or a job failure the self-remediation may include restarting a particular service or job. In contrast, for anomalies corresponding to PING, disk monitoring, or file system monitoring, the self-remediation may comprise automatically creating a ticket.

In some aspects, upon determining the self-remediation exceeds a configurable number of attempts or duration, initiating component 206 automatically performs an action. For example, initiating component 206 may automatically initiate an alert corresponding to the anomaly. In another example, initiating component 206 may automatically create a ticket corresponding to the anomaly.

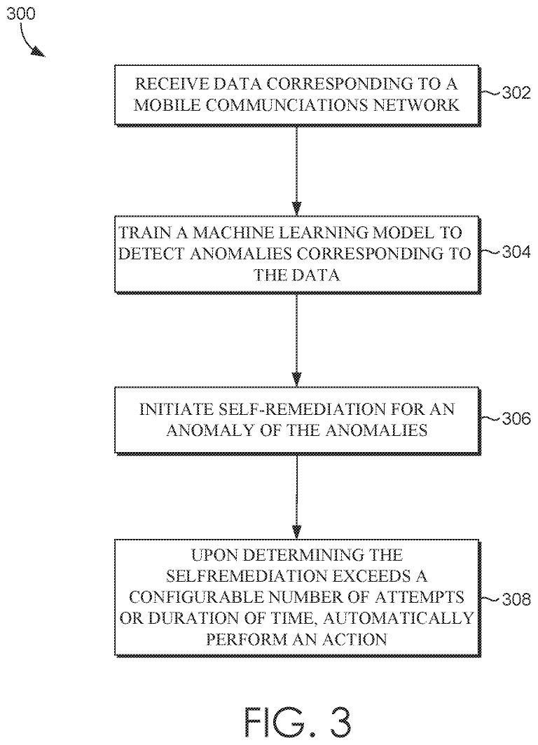

Referring to FIG. 3, a flow diagram is provided depicting a method 300 for providing a zero touch operations and self-healing data platform, in accordance with aspects of the present invention. Method 300 may be performed by any computing device (such as computing device described with respect to FIG. 4) with access to a self-healing engine (such as the one described with respect to FIGS. 1 and 2) or by one or more components of the network environment described with respect to FIG. 1 (such as UE 102, access point 114, or self-healing engine 130).

At step 302, data corresponding to a mobile communications network is received from a plurality of sources. For example, the data may include event data records, call data records, and/or location session records.

At step 304, a machine learning model is trained to detect anomalies corresponding to the data. In some aspects, the anomaly may correspond to Vintela Authentication Services (VASD), input/output (I/O) error, redundant array of independent disks (RAID), or backup battery unit (BBU). In other aspects, the anomaly may correspond to packet inter-network groper (PING), disk monitoring, or file system monitoring. In yet another example, the anomaly may correspond to a job failure.

At step 306, self-remediation is initiated for an anomaly of the anomalies. In some aspects, self-remediation comprises automated restarting of faulty platform services. In some aspects, self-remediation comprises automated load balancing of over-utilized system resources. For example, for anomalies corresponding to VASD, I/O error, RAID, BBU, or a job failure the self-remediation may include restarting a particular service or job. In contrast, for anomalies corresponding to PING, disk monitoring, or file system monitoring, the self-remediation may comprise automatically creating a ticket.

At step 308, upon determining the self-remediation exceeds a configurable number of attempts or duration, an action is automatically performed. For example, the action may include automatically initiating an alert corresponding to the anomaly. In another example, the action may include automatically creating a ticket corresponding to the anomaly.

Embodiments of the technology described herein may be embodied as, among other things, a method, a system, or a computer-program product. Accordingly, the embodiments may take the form of a hardware embodiment, or an embodiment combining software and hardware. The present technology may take the form of a computer-program product that includes computer-useable instructions embodied on one or more computer-readable media. The present technology may further be implemented as hard-coded into the mechanical design of network components and/or may be built into a broadcast cell or central server.

Computer-readable media includes both volatile and non-volatile, removable and non-removable media, and contemplate media readable by a database, a switch, and/or various other network devices. Network switches, routers, and related components are conventional in nature, as are methods of communicating with the same. By way of example, and not limitation, computer-readable media may comprise computer storage media and/or non-transitory communications media.

Computer storage media, or machine-readable media, may include media implemented in any method or technology for storing information. Examples of stored information include computer-useable instructions, data structures, program modules, and other data representations. Computer storage media may include, but are not limited to, RAM, ROM, EEPROM, flash memory or other memory technology, CD-ROM, digital versatile discs (DVD), holographic media or other optical disc storage, magnetic cassettes, magnetic tape, magnetic disk storage, and/or other magnetic storage devices. These memory components may store data momentarily, temporarily, and/or permanently, and are not limited to the examples provided.

Communications media typically store computer-useable instructions—including data structures and program modules—in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

Referring to FIG. 4, a block diagram of an exemplary computing device 400 suitable for use in implementations of the technology described herein is provided. In particular, the exemplary computer environment is shown and designated generally as computing device 400. Computing device 400 is but one example of a suitable computing environment and is not intended to suggest any limitation as to the scope of use or functionality of the invention. Neither should computing device 400 be interpreted as having any dependency or requirement relating to any one or combination of components illustrated. It should be noted that although some components in FIG. 4 are shown in the singular, they may be plural. For example, the computing device 400 might include multiple processors or multiple radios. In aspects, the computing device 400 may be a UE/WCD, or other user device, capable of two-way wireless communications with an access point. Some non-limiting examples of the computing device 400 include a cell phone, tablet, pager, personal electronic device, wearable electronic device, activity tracker, desktop computer, laptop, PC, and the like.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

As shown in FIG. 4, computing device 400 includes a bus 410 that directly or indirectly couples various components together, including memory 412, processor(s) 414, presentation component(s) 416 (if applicable), radio(s) 424, input/output (I/O) port(s) 418, input/output (I/O) component(s) 420, and power supply(s) 422. Although the components of FIG. 4 are shown with lines for the sake of clarity, in reality, delineating various components is not so clear, and metaphorically, the lines would more accurately be grey and fuzzy. For example, one may consider a presentation component such as a display device to be one of I/O components 420. Also, processors, such as one or more processors 414, have memory. The present disclosure hereof recognizes that such is the nature of the art, and reiterates that FIG. 4 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of the present disclosure and refer to “computer” or “computing device.”

Memory 412 may take the form of memory components described herein. Thus, further elaboration will not be provided here, but it should be noted that memory 412 may include any type of tangible medium that is capable of storing information, such as a database. A database may be any collection of records, data, and/or information. In one embodiment, memory 412 may include a set of embodied computer-executable instructions that, when executed, facilitate various functions or elements disclosed herein. These embodied instructions will variously be referred to as “instructions” or an “application” for short.

Processor 414 may actually be multiple processors that receive instructions and process them accordingly. Presentation component 416 may include a display, a speaker, and/or other components that may present information (e.g., a display, a screen, a lamp (LED), a graphical user interface (GUI), and/or even lighted keyboards) through visual, auditory, and/or other tactile cues.

Radio 424 represents a radio that facilitates communication with a wireless telecommunications network. Illustrative wireless telecommunications technologies include CDMA, GPRS, TDMA, GSM, and the like. Radio 424 might additionally or alternatively facilitate other types of wireless communications including Wi-Fi, WiMAX, LTE, 3G, 4G, LTE, mMIMO/5G, NR, VOLTE, or other VoIP communications. As can be appreciated, in various embodiments, radio 424 can be configured to support multiple technologies and/or multiple radios can be utilized to support multiple technologies. A wireless telecommunications network might include an array of devices, which are not shown so as to not obscure more relevant aspects of the invention. Components such as a base station, a communications tower, or even access points (as well as other components) can provide wireless connectivity in some embodiments.

The input/output (I/O) ports 418 may take a variety of forms. Exemplary I/O ports may include a USB jack, a stereo jack, an infrared port, a firewire port, other proprietary communications ports, and the like. Input/output (I/O) components 420 may comprise keyboards, microphones, speakers, touchscreens, and/or any other item usable to directly or indirectly input data into the computing device 400.

Power supply 422 may include batteries, fuel cells, and/or any other component that may act as a power source to supply power to the computing device 400 or to other network components, including through one or more electrical connections or couplings. Power supply 422 may be configured to selectively supply power to different components independently and/or concurrently.

Many different arrangements of the various components depicted, as well as components not shown, are possible without departing from the scope of the claims below. Embodiments of our technology have been described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

The invention claimed is:

1. A method for providing a zero touch operations and self-healing data platform, the method comprising:
receiving data corresponding to a mobile communications network, the data received from a plurality of sources;
training a machine learning model to detect anomalies corresponding to the data;
initiating self-remediation for an anomaly of the anomalies; and
upon determining the self-remediation exceeds a configurable number of attempts or duration of time, automatically performing an action.

2. The method of claim 1, wherein the action includes automatically initiating an alert corresponding to the anomaly.

3. The method of claim 1, wherein the action includes automatically creating a ticket corresponding to the anomaly.

4. The method of claim 1, wherein the anomaly corresponds to Vintela Authentication Services (VASD), input/output (I/O) error, redundant array of independent disks (RAID), or backup battery unit (BBU).

5. The method of claim 1, wherein the anomaly corresponds to packet inter-network groper (PING), disk monitoring, or file system monitoring.

6. The method of claim 1, further comprising processing the data.

7. The method of claim 6, wherein processing the data comprises:
reading one or more files corresponding to the data; and
queueing the one or more files for job scheduling.

8. The method of claim 7, wherein the anomaly corresponds to a job failure.

9. A non-transitory computer storage media storing computer-usable instructions that, when used by one or more processors, cause the one or more processors to perform operations, the operations comprising:
receiving data corresponding to a mobile communications network, the data received from a plurality of sources;
training a machine learning model to detect anomalies corresponding to the data;
initiating self-remediation for an anomaly of the anomalies; and
upon determining the self-remediation exceeds a configurable number of attempts or duration of time, automatically performing an action.

10. The media of claim 9, wherein the action includes automatically initiating an alert corresponding to the anomaly.

11. The media of claim 9, wherein the action includes automatically creating a ticket corresponding to the anomaly.

12. The media of claim 9 wherein the anomaly corresponds to Vintela Authentication Services (VASD), input/output (I/O) error, redundant array of independent disks (RAID), or backup battery unit (BBU).

13. The media of claim 9, wherein the anomaly corresponds to packet inter-network groper (PING), disk monitoring, or file system monitoring.

14. The media of claim 9, further comprising processing the data.

15. The media of claim 14, wherein processing the data comprises:
reading one or more files corresponding to the data; and
queueing the one or more files for job scheduling.

16. The media of claim 15, wherein the anomaly corresponds to a job failure.

17. A system for providing a zero touch operations and self-healing data platform, the system comprising:
one or more UEs; and
a node configured to wirelessly communicate with the one or more UEs, wherein the node is configured to:
(1) receive data corresponding to a mobile communications network, the data received from a plurality of sources;
(2) train a machine learning model to detect anomalies corresponding to the data;
(3) initiate self-remediation for an anomaly of the anomalies; and
(4) upon determining the self-remediation exceeds a configurable number of attempts or duration of time, automatically perform an action.

18. The system of claim 17, wherein the action includes automatically initiating an alert corresponding to the anomaly.

19. The system of claim 17, wherein the action includes automatically creating a ticket corresponding to the anomaly.

20. The system of claim 17, wherein the data comprises event data records, call data records, and location session records.
